(19) United States
(12) Patent Application Publication
(10) Pub. No.: US 2009/0175293 A1
(43) Pub. Date: Jul. 9, 2009

(54) METHOD AND SYSTEM FOR TRANSMITTING MESSAGES OVER A FORWARD LINK SIGNALING CHANNEL

(75) Inventors: Linfeng Xia, Shenzhen (CN); Yinggang Du, Shenzhen (CN); Bin Li, Shenzhen (CN); Yi Luo, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/399,374

(22) Filed: Mar. 6, 2009

Related U.S. Application Data
(63) Continuation of application No. PCT/CN2007/002534, filed on Aug. 22, 2007.

(30) Foreign Application Priority Data
Sep. 8, 2006 (CN) 200610128785.6

(51) Int. Cl. H04J 3/02; H04L 27/28

(52) U.S. Cl. 370/462; 375/260

(57) ABSTRACT

A method and system for transmitting messages over an F-SCCH in wireless communication field are disclosed. The method includes the following steps: acquiring a transmission type according to a negotiation between a terminal and a network during a link initialization; configuring a bit number occupied by a message type of messages of the F-SCCH; communicating, by the network, messages with the terminal according to the configured bit number of the message type based on the determined transmission type. With the present invention, redundancy of channel configuration may be decreased, channel configuration of the conventional art is simplified, hence reducing resource occupancy and improving resource utilization of channels.

### CROSS-REFERENCE TO RELATED APPLICATIONS

This application is a continuation of International Patent Application No. PCT/CN2007/002534, filed Aug. 22, 2007, which claims priority to Chinese Patent Application No. 200610128785.6, filed Sep. 8, 2006, both of which are hereby incorporated by reference in their entirety.

### FIELD OF THE INVENTION

The present invention relates to a method and system for transmitting messages over a forward link signaling channel, and particularly to a method and system for transmitting messages over the forward link signaling channel in a wireless communication field.

### BACKGROUND

In wireless communication protocols, a forward link shared signaling channel (F-SCCH) is very important. As an important part of a forward link control channel (FCCH), the F-SCCH may transmit contents such as a forward and reverse data access grant and a channel assignment. An access terminal (AT) may determine whether to access the network and obtain resource information assigned by the system according to information received from the F-SCCH.

The F-SCCH may include a plurality of signaling messages for access grant, resource assignment and so on. There are many types of messages and each of the messages may include a plurality of fields such as a message type (Blocktype), and a resource number (ChanID). Because communicating with a specified AT is needed, the messages may also include information of a target MACID (may be a MACID for broadcast). The information of the MACID may be directly included in a field of the messages or included in information of the messages through being scrambled by a scrambling code. FIG. 1 is a schematic diagram illustrating a flow for transmitting signaling messages over the F-SCCH according to the 802.20 protocol.

The following Table 1 illustrates structures of the messages transmitted over the F-SCCH in the conventional art and in the table, columns represent different fields and rows represent different messages.

TABLE 1

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 3 | 9-11 | 1 | 6-8 | 4-6 | 2 | 1 | 6 | 1 | 2 |
| Access Grant | 000 | 1 | 0 | 0 | 0 | 0 | 0 | 1 | 0 | 0 |
| Message | | | | | | | | | | |
| Forward Link | 010 | 0 | 1 | 1 | 1 | 0 | 1 | 0 | 1 | 0 |
| Assignment | | | | | | | | | | |
| Message | | | | | | | | | | |
| (FLAM) | | | | | | | | | | |
| Reverse Link | 011 | 0 | 1 | 1 | 1 | 0 | 1 | 0 | 1 | 0 |
| Assignment | | | | | | | | | | |
| Message | | | | | | | | | | |
| (RLAM) | | | | | | | | | | |
| Multiple | 100 | To Be | TBD | TBD | TBD | TBD | TBD | TBD | TBD | TBD |
| Codeword | | Determined | | | | | | | | |
| Forward Link | | (TBD) | | | | | | | | |
| Assignment | | | | | | | | | | |
| Message 1 | | | | | | | | | | |
| (MCW FLAM 1) | | | | | | | | | | |
| Multiple | 101 | TBD | TBD | TBD | TBD | TBD | TBD | TBD | TBD | TBD |
| Codeword | | | | | | | | | | |
| Forward Link | | | | | | | | | | |
| Assignment | | | | | | | | | | |
| Message 2 | | | | | | | | | | |
| (MCW FLAM 2) | | | | | | | | | | |
| Single | 110 | TBD | TBD | TBD | TBD | TBD | TBD | TBD | TBD | TBD |
| Codeword | | | | | | | | | | |
| Forward Link | | | | | | | | | | |
| Access Block | | | | | | | | | | |
| (SCW FLAB) | | | | | | | | | | |

The following is a brief description of a procedure for a user to access a network in the conventional art.

An AT transmits an access probe sequence first. In response to the probe, an access network (AN) transmits an access grant message to the AT over the F-SCCH, to assign the MACID and transmit timing information, the access grant message being scrambled by a scrambling code sequence corresponding to the access probe sequence or the access sequence. The AT transmits a binding request that is scrambled by the assigned MACID. The AN transmits a binding response that is also scrambled by the MACID after receiving the binding request. The access procedure ends after the AT receives the binding response and the AT may start requesting data transfer and applying resource blocks. The AN transmits a resource assignment message to the AT.

As can be seen from the above procedure, the user's access may be in fact divided into two stages: an access requesting stage and a resource requesting stage. In the access requesting stage, the user needs to process the access grant message first and process other assignment messages after receiving the access grant message and obtaining the access grant (MACID), the access grant message being scrambled by an access prefix sequence or a scrambling code corresponding to the sequence.

At the same time, while accessing, the user needs to report whether the user is a single-input single-output (SISO) user or a multiple-input multiple-output (MIMO) user.

However, practically, structures of these messages in the conventional art are redundant and are not fully utilized at present. Furthermore, there is no technical solution to reducing the number of bytes of the Blocktype to make the best of the F-SCCH.

### SUMMARY OF THE INVENTION

Embodiments of the present invention provide a method and system for transmitting messages over the F-SCCH, to make the best of F-SCCH resources.

The method for transmitting messages over the F-SCCH includes: acquiring a transmission type according to a negotiation between an access terminal (AT) and an access network (AN) during a link initialization; configuring a bit number occupied by a message type in the F-SCCH; and communicating, by the AN, messages with the AT over the F-SCCH according to the configured bit number of the message type based on the determined transmission type.

Preferably, three message types including Access Grant, forward link assignment message (FLAM) and reverse link assignment message (RLAM) are used for transmission when the transmission type is single-input single-output (SISO); or four message types including the access grant message, a multiple codeword forward link assignment message 1 (MCW FLAM 1), a multiple codeword forward link assignment message 2 (MCW FLAM 2) and the RLAM are used for transmission when the transmission type is multiple-input multiple-output multiple codeword (MIMO MCW); or three message types including the access grant message, a single codeword forward link access block (SCW FLAB) and the RLAM are used for transmission when the transmission type is multiple-input multiple-output single codeword (MIMO SCW).

Preferably, a message type including an access grant message is separately used for transmission; and two message types including the FLAM and the RLAM are used for transmission when the transmission type is the SISO, or three message types including the RLAM, the MCW FLAM 1 and the MCW FLAM 2 are used for transmission when the transmission type is MIMO MCW, or two message types including the RLAM and the SCW FLAB are used for transmission when the transmission type is MIMO SCW.

Preferably, a message type including an access grant message is separately used for transmission; two message types including the FLAM and the RLAM are used for transmission when the transmission type is the SISO, or three message types including the RLAM, the MCW FLAM 1 and the MCW FLAM 2 are used for transmission when the transmission type is the MIMO MCW, or two message types including the RLAM and the SCW FLAB are used for transmission when the transmission type is the MIMO SCW; and the AT transmits the MCW FLAM 1 and the MCW FLAM 2 messages in turn when transmitting assignment messages to the AN in case the transmission type is the MIMO MCW.

A system for transmitting messages over an F-SCCH in a wireless communication system including an AN and an AT, includes an acquisition module adapted to acquire a transmission type according to a negotiation between the AT and the AN during a link initialization. The system further includes: a first configuration module adapted to configure a bit number occupied by a message type in the F-SCCH; and a first transmission module adapted to transmit messages between the AN and the AT over the F-SCCH according to the bit number of the message type configured by the first configuration module and the transmission type determined by the acquisition module.

Preferably, the transmission type is SISO, MIMO MCW or MIMO SCW.

Preferably, the first transmission module includes a first transmission unit, a second transmission unit and a third transmission unit. The first transmission unit is adapted to transmit messages when the transmission type is the SISO, the message type in the messages including Access Grant, FLAM and RLAM. The second transmission unit is adapted to transmit messages when the transmission type is MIMO MCW, the message type in the messages including the access grant message, MCW FLAM 1, MCW FLAM 2 and RLAM. The third transmission unit is adapted to transmit messages when the transmission type is MIMO SCW, the message type in the messages including Access Grant, SCW FLAB and RLAM.

Preferably, the first transmission module includes a fourth transmission unit, a fifth transmission unit, a sixth transmission unit and a seventh transmission unit. The fourth transmission unit is adapted to transmit an access grant message; the fifth transmission unit is adapted to transmit messages when the transmission type is the SISO, the message type in the messages including FLAM and RLAM. The sixth transmission unit is adapted to transmit messages when the transmission type is MIMO MCW, the message type in the messages including RLAM, MCW FLAM 1, and MCW FLAM 2. The seventh transmission unit is adapted to transmit messages when the transmission type is MIMO SCW, the message type in the messages including SCW FLAB and RLAM.

Preferably, the first transmission module includes a fourth transmission unit, a fifth transmission unit, a sixth transmission unit and a seventh transmission unit. The fourth transmission unit is adapted to transmit an access grant message. The fifth transmission unit is adapted to transmit messages when the transmission type is SISO, the message type in the messages including FLAM and RLAM. The sixth transmission unit is adapted to transmit messages when the transmission type is MIMO MCW, the message type in the messages including RLAM, MCW FLAM 1, and MCW FLAM 2. The seventh transmission unit is adapted to transmit messages when the transmission type is MIMO SCW, the message type in the messages including SCW FLAB and RLAM. The sixth transmission unit is adapted to transmit MCW FLAM 1 and MCW FLAM 2 in turn when the AT transmits assignment messages to the AN in case the transmission type is MIMO MCW.

A method for transmitting messages over an F-SCCH, includes: setting the number of modes of adding information according to the number of transmission types included in a message type of messages of the F-SCCH and configuring a bit number occupied by the message type according to the number of modes of adding information; adding information to messages transmitted between an AN and an AT according to the mode of adding information; transmitting the messages according to the configured bit number of the message type; and confirming a transmission type through the added information and processing the messages with the transmission type.

Preferably, the mode of adding information is interleaving or scrambling. CRC bits are added in the added information of the transmitted messages. Preferably, CRC bits are added to the end of the transmitted messages.

Preferably, confirming the transmission type through the added information is confirming the transmission type through the CRC bits in the added information.

Preferably, the method further includes: acquiring the transmission type according to a negotiation between the AT and the AN during a link initialization; and configuring the bit number occupied by the message type according to the number of modes of adding information when the transmission type is acquired.

A system for transmitting messages over an F-SCCH includes: a second configuration module adapted to set the number of modes of adding information according to the number of transmission types included in a message type of messages of the F-SCCH and configure a bit number occupied by the message type according to the number of modes of adding information; an information adding module adapted to add information to messages transmitted between an AN and an AT according to the mode of adding information; and a second transmission module adapted to transmit the messages according to the configured bit number of the message type, confirm the transmission type through the added information and process the messages with the transmission type.

Preferably, the mode of adding information is interleaving or scrambling.

CRC bits are added in the added information of the transmitted messages. Preferably, CRC bits are added to the end of the transmitted messages. Preferably, confirming the transmission type through the added information is confirming the transmission type through the CRC bits in the added information.

Preferably, the system further includes an acquisition module adapted to acquire the transmission type according to a negotiation between the AT and the AN during a link initialization, and the second configuration module is adapted to configure the bit number occupied by the message type according to the number of modes of adding information when the transmission type is acquired.

Beneficial effects of the present invention are as follows.

In the conventional art, the two stages in an access process of the AT, an access requesting stage and a resource requesting stage, are naturally distinguished and not overlapped. SISO users and MIMO users are also distinguishable. At the same time, the MIMO users may be classified into MCW users and SCW users. All of these may be commonly agreed on by the AN and the AT during the link initialization. Even if switching occurs among SISO, SCW and MCW during a service, it can be known in advance via the negotiation between the AN and the AT through an upper layer signaling. According to the above principle, the present invention utilizes reuse of the message type in different stages to reduce redundancy of the channel structure, simplify channel structure of the conventional art, hence decreasing resource occupancy and improving resource utilization of channels.

In the present invention, messages are transmitted between the AT and the AN in form of adding information and CRC bits in the original message are further incorporated into the added information to distinguish the kind of the message type and identify various transmission types. Therefore channel task for carrying the transmission type identifying information is reduced. Thus redundancy of channel configuration is decreased, channel configuration of the conventional art is simplified, hence reducing resource occupancy and improving resource utilization of channels.

### BRIEF DESCRIPTION OF DRAWINGS

FIG. 1 is a schematic diagram illustrating a flow for signaling messages transmission over the F-SCCH according to the 802.20 protocol in the conventional art;

FIG. 2 is a schematic diagram illustrating message transmission over the F-SCCH according to an embodiment of the present invention;

FIG. 3 is an architecture diagram illustrating a system for transmitting messages over the F-SCCH according to an embodiment of the present invention;

FIG. 4 is a schematic diagram illustrating a method for transmitting messages over the F-SCCH according to another embodiment of the present invention;

FIG. 5 is a schematic diagram illustrating a method carried out by a transmitting terminal when an interleaving pattern is used to indicate Blocktype according to another embodiment of the invention;

FIG. 6 is a schematic diagram illustrating a method carried out by a receiving terminal when an interleaving pattern is used to indicate Blocktype according to another embodiment of the invention; and

FIG. 7 is an architecture diagram illustrating a system for transmitting messages over the F-SCCH according to another embodiment of the present invention.

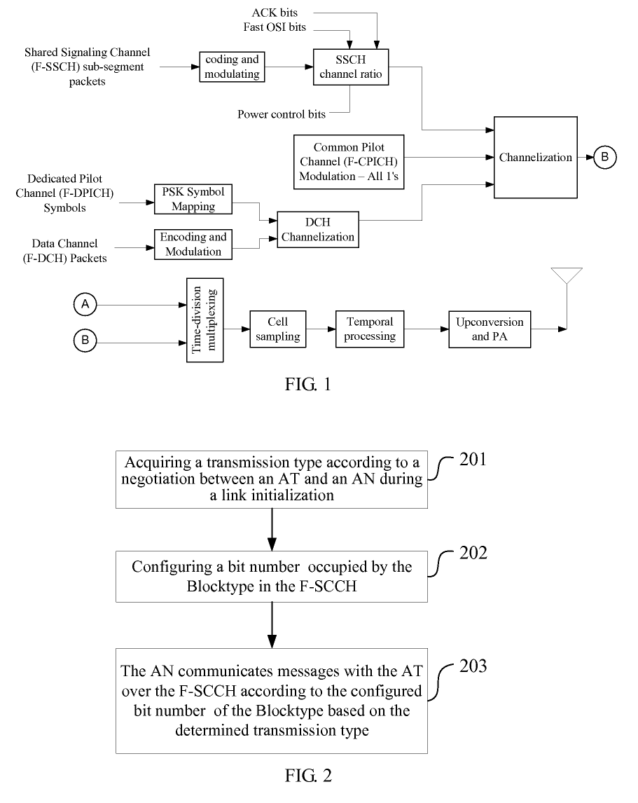

### DETAILED DESCRIPTION

Specific embodiments of the present invention are described below with reference to the accompanying drawings.

FIG. 2 is a schematic diagram illustrating message transmission over the F-SCCH according to an embodiment of the present invention, which includes the following steps:

Step 201: A transmission type is acquired on the basis of a negotiation between an AT and an AN during a link initialization.

While the user accesses, the user reports first that the user is a SISO user or a MIMO user, and therefore after the access is completed, the transmission type is known to the AN and the AT and hence available.

Step 202: A bit number occupied by the message type in the F-SCCH is configured.

Practically, the user's access may be divided into two stages: an access requesting stage and a resource requesting stage, and the two stages may not overlap with each other. That is, in the access requesting stage, the user may processes the access grant message first and then process other assignment messages only after receiving the access grant message and obtaining the access grant (obtaining the MACID). The access grant message may be scrambled by an access prefix sequence or a scrambling code corresponding to the sequence. Once the access grant is obtained, to process the access grant message may not be needed any more and subsequent messages may be all scrambled by the MACID. Therefore, the access grant message and the assignment messages may occur in different stages respectively and the message type (Blocktype) of the access grant message and the assignment messages may be reused. In the embodiment, the Blocktype may be taken as an example to explain the message type. That is, the type of the assignment messages of the SISO user and the MIMO user may be reused, namely the same Blocktype may be used. Also, in the embodiment, the bit number occupied by the Blocktype in the F-SCCH may be configured to make the best of the F-SCCH resources.

Step 203: Based on the determined transmission type, the AN transmits messages with the AT over the F-SCCH according to the configured bit number of the message type.

In this step, for other messages, a transmission format of the F-SCCH is determined first according to a known transmission mode (SISO, SCW, or MCW), so the transmission format may be reused between different transmission modes to decrease the bit number of the Blocktype while the transmission type is not caused to be indistinguishable. For example, it is assumed that the bit number of the Blocktype is 2, 00, 01, 10 and 11 in the Blocktype may be used for all the transmission modes, that is, up to 12 types for the Blocktype may be represented. However, in the conventional art, 4 bits are needed to represent 12 types for the Blocktype.

### EMBODIMENT ONE

In this embodiment, to keep certain compatibility and extendibility, reuse of the Blocktype may be only based on the transmission type. That is, in this embodiment, after that the user's type is SISO, MIMO MCW, or MIMO SCW is acquired, two bits may be used in the Blocktype. The structures of the messages in the F-SCCH for various transmission types are designed as follows.

For a SISO user:

TABLE 2

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| Access | 00 | 1 | 0 | 0 | 0 | 0 | 0 | 1 | 0 | 0 |
| Grant | | | | | | | | | | |
| Message | | | | | | | | | | |
| FLAM | 01 | 0 | 1 | 1 | 1 | 0 | 1 | 0 | 1 | 0 |
| RLAM | 10 | 0 | 1 | 1 | 1 | 0 | 1 | 0 | 1 | 0 |

For a MIMO MCW user:

TABLE 3

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| Access | 00 | 1 | 0 | 0 | 0 | 0 | 0 | 1 | 0 | 0 |
| Grant | | | | | | | | | | |
| Message | | | | | | | | | | |
| MCW | 01 | TBD | TBD | TBD | TBD | TBD | TBD | TBD | TBD | TBD |
| FLAM 1 | | | | | | | | | | |
| MCW | 11 | TBD | TBD | TBD | TBD | TBD | TBD | TBD | TBD | TBD |
| FLAM 2 | | | | | | | | | | |
| RLAM | 10 | 0 | 1 | 1 | 1 | 0 | 1 | 0 | 1 | 0 |

For a MIMO SCW user:

TABLE 4

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| Access | 00 | 1 | 0 | 0 | 0 | 0 | 0 | 1 | 0 | 0 |
| Grant | | | | | | | | | | |
| Message | | | | | | | | | | |
| SCW | 11 | TBD | TBD | TBD | TBD | TBD | TBD | TBD | TBD | TBD |
| FLAB | | | | | | | | | | |
| RLAM | 10 | 0 | 1 | 1 | 1 | 0 | 1 | 0 | 1 | 0 |

### EMBODIMENT TWO

Further, in this embodiment, the access grant message may be separated from other messages of the F-SCCH and thus not participate in sorting in the Blocktype, but the access grant message has the same length as other messages. For the other messages, the transmission format of the F-SCCH may be determined according to the transmission mode (SISO, SCW, or MCW). The transmission format may be reused among different transmission modes to decrease the bit number of the Blocktype. For example, it is assumed that the bit number of the Blocktype is 2, 00, 01, 10 and 11 in the Blocktype may be used for all the transmission modes, that is, up to 12 types for the Blocktype may be represented. Whereas in the conventional art, 4 bits are needed to represent 12 types for the Blocktype. Meanwhile, reuse of the Blocktype is based on the transmission type, and the structures of the messages of the F-SCCH are designed as follows when the MIMO user is classified into an MCW user and an SCW user.

For an access grant message:

TABLE 5

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| Access | Reserved | 1 | 0 | 0 | 0 | 0 | 0 | 1 | 0 | 0 |
| Grant | | | | | | | | | | |
| Message | | | | | | | | | | |

Here, the Blocktype of the access grant message in the table may be arbitrary and may also be the same as the following fields that are set as 0.

For a SISO user:

TABLE 6

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # | 2 | 9-11 | 1 | 6-8 | 4-6 | 2 | 1 | 6 | 1 | 2 |
| bits | | | | | | | | | | |
| FLAM | 00 | 0 | 1 | 1 | 1 | 0 | 1 | 0 | 1 | 0 |
| RLAM | 01 | 0 | 1 | 1 | 1 | 0 | 1 | 0 | 1 | 0 |

As can be seen from the table, there are 2 idle types for the Blocktype that are available for extension for the SISO user.

For a MIMO MCW user:

TABLE 7

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| RLAM | 01 | 0 | 1 | 1 | 1 | 0 | 1 | 0 | 1 | 0 |
| MCW | 10 | TBD | TBD | TBD | TBD | TBD | TBD | TBD | TBD | TBD |
| FLAM 1 | | | | | | | | | | |
| MCW | 11 | TBD | TBD | TBD | TBD | TBD | TBD | TBD | TBD | TBD |
| FLAM 2 | | | | | | | | | | |

As can be seen from the table, there is 1 idle type for the Blocktype that is available for extension for the MIMO MCW user.

For a MIMO SCW user:

TABLE 8

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 2 | 9-11 | 1 | 6-8 | 4-6 | 2 | 1 | 6 | 1 | 2 |
| RLAM | 01 | 0 | 1 | 1 | 1 | 0 | 1 | 0 | 1 | 0 |
| SCW | 10 | TBD | TBD | TBD | TBD | TBD | TBD | TBD | TBD | TBD |
| FLAB | | | | | | | | | | |

As can be seen from the table, there are 2 idle types for the Blocktype that are available for extension for the MIMO SCW user.

As compared with Embodiment One, the access grant message is excluded from participating in the sorting in the Blocktype in this embodiment, and thus new idle type(s) for the Blocktype is (are) generated for both the SISO user and the MIMO user for convenient extension of other message types.

### EMBODIMENT THREE

In this embodiment, the access grant message is separated from other messages of the F-SCCH and not participate in the sorting in the Blocktype, reuse of the Blocktype is based on the transmission type, and the MIMO user are classified into an MCW user and an SCW user. By simplifying the Blocktype of the MCW user, the Blocktype may be further decreased down to 1 bit. The structures of the messages of the F-SCCH may be designed as follows:

For an access grant message:

TABLE 9

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # bits | 1 | 9-11 | 1 | 6-8 | 4-6 | 2 | 1 | 6 | 1 | 2 |
| Access | Reserved | 1 | 0 | 0 | 0 | 0 | 0 | 1 | 0 | 0 |
| Grant | | | | | | | | | | |
| Message | | | | | | | | | | |

Note:
the Blocktype of the access grant message in the table may be arbitrary and may also be the same as the following fields that are set as 0.For a SISO user:

TABLE 10

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # | 1 | 9-11 | 1 | 6-8 | 4-6 | 2 | 1 | 6 | 1 | 2 |
| bits | | | | | | | | | | |
| FLAM | 0 | 0 | 1 | 1 | 1 | 0 | 1 | 0 | 1 | 0 |
| RLAM | 1 | 0 | 1 | 1 | 1 | 0 | 1 | 0 | 1 | 0 |

For a MIMO MCW user:

TABLE 11

| | Block | | | | | | | | | |
|---|---|---|---|---|---|---|---|---|---|---|
| Field | type | MACID | Persistent | ChanID | PF | Duration | Ext. TX | Timing | Suppl. | Rank |
| # | 1 | 9-11 | 1 | 6-8 | 4-6 | 2 | 1 | 6 | 1 | 2 |
| bits | | | | | | | | | | |
| RLAM | 0 | 0 | 1 | 1 | 1 | 0 | 1 | 0 | 1 | 0 |
| MCW | 1 | TBD | TBD | TBD | TBD | TBD | TBD | TBD | TBD | TBD |
| FLAM 1 | | | | | | | | | | |
| MCW | 1 | TBD | TBD | TBD | TBD | TBD | TBD | TBD | TBD | TBD |
| FLAM 2 | | | | | | | | | | |

For a MIMO SCW user:

TABLE 12

| | Block | | | | | | Ext. | | | |
|---|---|---|---|---|---|---|---|---|---|---|
| Field | type | MACID | Persistent | ChanID | PF | Duration | TX | Timing | Suppl. | Rank |
| # bits | 1 | 9-11 | 1 | 6-8 | 4-6 | 2 | 1 | 6 | 1 | 2 |
| RLAM | 0 | 0 | 1 | 1 | 1 | 0 | 1 | 0 | 1 | 0 |
| SCW | 1 | TBD | TBD | TBD | TBD | TBD | TBD | TBD | TBD | TBD |
| FLAB | | | | | | | | | | |

In the present embodiment, the RLAM of the MIMO MCW user and the MCW FLAM 1 are distinguished by the Blocktype, while the MCW FLAM 2 uses the same Blocktype as the MCW FLAM 1. Here, it is specified that the MCW FLAM 1 and the MCW FLAM 2 messages are transmitted in turn when the AN transmitting the assignment messages. This specification is reasonable because the two messages accomplish resource assignment for the MCW user jointly and any one of the two messages is not negligible. The RLAM is scrambled according to the MACID when the RLAM is transmitted.

According to the above design concept, an embodiment of the present invention also provides a system for transmitting messages over the F-SCCH. The embodiment of the system will be described below with reference to drawings.

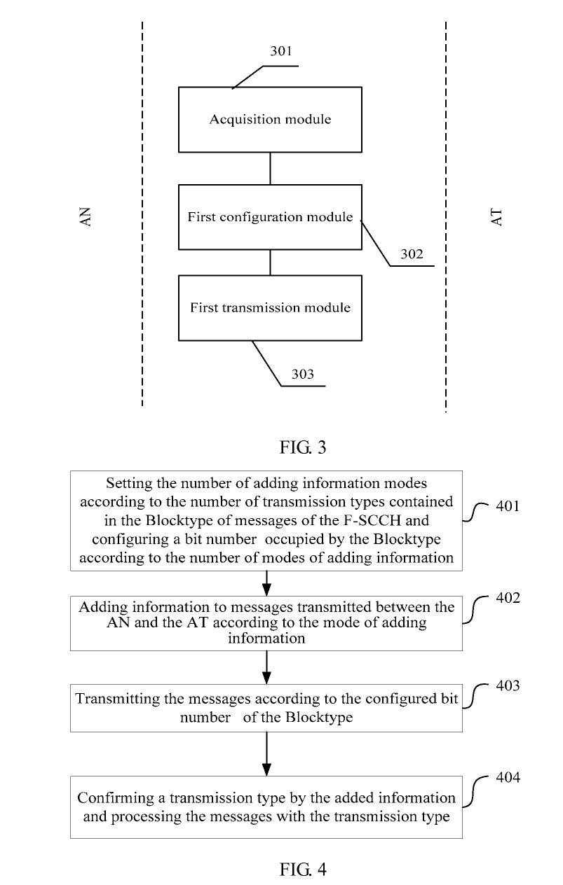

FIG. 3 is an architecture diagram illustrating a system for transmitting messages over the F-SCCH according to an embodiment of the present invention. As shown in the figure, the system is suitable for a wireless communication system including an AN and an AT, and includes an acquisition module 301, a first configuration module 302 and a first transmission module 303.

The acquisition module 301 is adapted to acquire a transmission type according to a negotiation between the AT and the AN during a link initialization.

The first configuration module 302 is adapted to configure a bit number occupied by a message type in the F-SCCH. In the embodiment, the message type with the bit number less than 3 and greater than 0 is taken as an example.

The first transmission module 303 is adapted to transmit messages between the AN and the AT over the F-SCCH according to the bit number of the message type configured by the first configuration module and the transmission type acquired by the acquisition module.

In the embodiment, the transmission type may be a SISO, a MIMO MCW, or a MIMO SCW. However, as can be known from the present design concept, the present invention is not limited to the three transmission types. In the following, the system is described based on various transmission types under various configurations of the bit number of the Blocktype.

When the bit number of the Blocktype is set to 2, the first transmission module 303 further includes a first transmission unit, a second transmission unit and a third transmission unit. The first transmission unit is adapted to transmit messages in case that the transmission type is SISO, the second transmission unit is adapted to transmit messages in case that the transmission type is MIMO MCW, and the third transmission unit is adapted to transmit messages in case that the transmission type is MIMO SCW.

According to the same principle, the structures of the messages transmitted by the first, second and third transmission units in the embodiment may be the same as the structures of the messages transmitted in Embodiment One.

In an embodiment, the access grant message may be separated from other messages of the F-SCCH and not participate in the sorting in the Blocktype, but the access grant message has the same length as the other messages. Therefore, when the bit number of the Blocktype is set to 2, the first transmission module may further includes a fourth transmission unit, a fifth transmission unit, a sixth transmission unit and a seventh transmission unit. The fourth transmission unit is adapted to transmit the access grant message, the fifth transmission unit is adapted to transmit messages in case that the transmission type is SISO, the sixth transmission unit is adapted to transmit messages in case that the transmission type is MIMO MCW and the seventh transmission unit is adapted to transmit messages in case that the transmission type is MIMO SCW.

The structures of the messages transmitted by the fourth, fifth, sixth and seventh transmission units in the embodiment may be the same as the structures of the messages transmitted in Embodiment Two.

In another embodiment, the access grant message is separated, reuse of the Blocktype is based on transmission type, and the MIMO user is classified into an MCW user and an SCW user. According to this embodiment, the Blocktype of the MCW user may further be simplified to decrease the Blocktype down to 1 bit.

In this embodiment, the structures of the messages transmitted by the fourth, fifth, sixth and seventh transmission units may be the same as the structures of the messages transmitted in Embodiment Three. The RLAM of the MIMO MCW user and the MCW FLAM 1 are distinguished by the Blocktype, and the MCW FLAM 2 uses the same Blocktype as the MCW FLAM 1. Here, it is specified that the transmission type may be identified by transmitting the MCW FLAM 1 and the MCW FLAM 2 in turn when the AN transmits the assignment messages. This specification is reasonable because the two messages accomplish resource assignment for the MCW user jointly and any one of the two messages is not negligible. The RLAM is scrambled by the MACID when the RLAM is transmitted.

It can be seen from the above that the channel structure of the F-SCCH is simplified, channel resources are saved, channel utilization ratio is improved and at the same time overhead and complexity are not increased.

The Blocktype is decreased by 1-2 bits or multiple idle types of the Blocktype are provided for message expansion without increasing any overhead or complexity. The saved resources for the Blocktype may also be used for extending the Blocktype.

The scheme according to another embodiment of the present invention will be described below with reference to the accompanying drawings.

In this scheme, the number of modes of adding information is set according to the number of transmission types included in the message type of the messages of the F-SCCH, the bit number occupied by the message type is configured according to the number of modes of adding information, and therefore corresponding transmission types may be identified by the number of modes of adding information without using the bit number occupied by the message type in the F-SCCH, hence making the best of channel resources.

Information is added to messages transmitted between the AN and the AT according to the mode of adding information. After information is added to the transmitted information, confirmation of the information between the AN and the AT also confirms the transmission type at the same time. Thus, confirming the transmission type through the added information allows processing messages therebetween with the corresponding transmission type.

In this embodiment, to distinguish different message types, adding information may use different interlacing patterns to interleave information sequence or different scrambling codes are used for the information sequence. Practically, there are various implementations for adding information, and scrambling and interleaving are used in this embodiment. According to this embodiment, transmission types need not to be distinguished by distinguishing added information and at the same time the resources of the message type are saved as much as possible or even the message type may be omitted completely.

In an exemplary implementation, CRC bits in the original message may be used as an identification mark in the added information. That is, the receiving terminal first conducts other processings such as demodulating and decoding, simply performs anti-interleaving of data with K types of interlacing patterns respectively according to different transmission methods after obtaining a combined sequence of information bits and the CRC bits, and outputs one in which the CRC bits are verified to be correct.

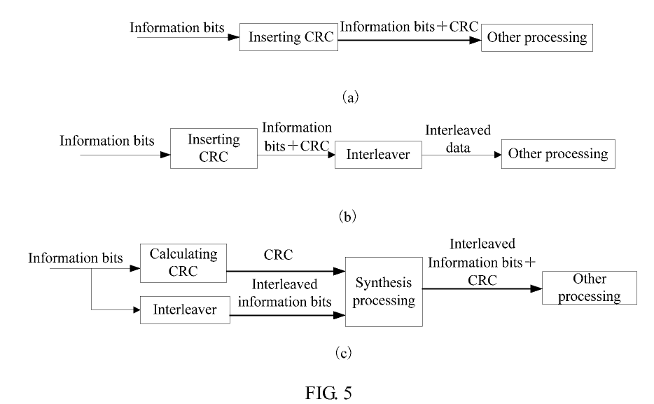

FIG. 4 is a schematic diagram illustrating a method for transmitting messages over the F-SCCH according to another embodiment of the present invention. As shown in the figure, the method includes the following steps.

Step 401: The number of modes of adding information is set according to the number of transmission types included in the Blocktype of the messages of the F-SCCH and the bit number occupied by the Blocktype is configured according to the number of modes of adding information.

Step 402: Information is added to messages transmitted between the AN and the AT according to the mode of adding information.

Step 403: The messages are transmitted according to the configured bit number of the Blocktype.

Step 404: A transmission type is confirmed by the added information and the messages are processed with the transmission type.

In this embodiment, for each message, it is assumed that there are 2N types originally needed for the Blocktype, that is, N bits are needed. To decrease resources occupied by each message, M (0≦M≦N−1) bits may be used to express the Blocktype. Accordingly, the types for the Blocktype that may be expressed are 2^{M}. Thus (2^{N}/2^{M}=2^{N-M}) different interlacing patterns are needed. For example, the current Blocktype is 3 bits, and if the Blocktype is needed to decrease to 1 bit, 4 different interlacing patterns are needed for distinguishing. FIG. 5 is a schematic diagram illustrating a method carried out by a transmitting terminal when an interleaving pattern is used to indicate the Blocktype according to another embodiment of the present invention. As shown in the figure, (a) illustrates a procedure for transmitting messages according to the conventional art protocol, (b) illustrates the first transmitting method used in the present embodiment and (c) illustrates the second transmitting method used in the present embodiment. The methods illustrated by (b) and (c) are different in that whether the CRC bits are involved in the interleaving process.

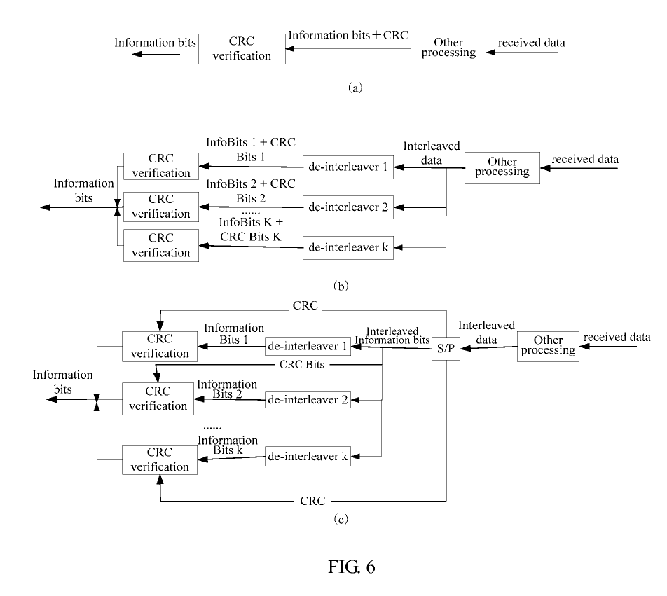

FIG. 6 is a schematic diagram illustrating a method carried out by a receiving terminal when an interleaving pattern is used to indicate the Blocktype according to another embodiment of the present invention. As shown in the figure, (a) illustrates a receiving process of the conventional art protocol, (b) illustrates a receiving process corresponding to the first transmitting method of FIG. 5 and (c) illustrates a receiving process corresponding to the second transmitting method of FIG. 5. Serial numbers 1-K in the figure represent different de-interleavers, and K=2^{N-M}.

The receiving terminal first conducts other processing such as demodulating and decoding, and after acquiring the combined sequence of the information bits and the CRC bits, the processing is slight different according to different transmitting methods. For the first transmitting method, de-interleaving of the data is performed with K interlacing patterns respectively, the CRC bits are verified, and one in which the CRC bits are verified to be correct is outputted. For the second transmitting method, the combined sequence of the information bits and the CRC bits is separated, K types of de-interleaving processings of the information bits are performed, the CRC bits are verified, and one in which the CRC bits are verified to be correct is outputted.

In a specific implementation, the Blocktype may also be distinguished with different scrambling codes. For each message, it is assumed that 2N types for the Blocktype are needed originally, that is, N bits are needed. M (0≦M≦N−1) bits may be used to indicate the Blocktype and the types for the Blocktype that may be indicated are 2^{M}. Thus (2^{N}/2^{M}=2^{N-M}) different scrambling codes are needed. For example, the Blocktype is 3 bits at present, and if the Blocktype is needed to decrease down to 1 bit, 4 different scrambling codes are needed for distinguishing. The transmitting and receiving process for the scrambling code is the same as that for the interleaving pattern except for changing the interleaving and the de-interleaving to the scrambling and the de-scrambling.

In an exemplary implementation, to decrease complexity of the receiving process, the information bits are scrambled after the CRC bits are added and then other processings are performed. Thus, the receiving terminal only needs to try de-scrambling with different scrambling codes and verifies the CRC bits, without other complex operations such as multiple decoding.

In a specific implementation, letting M=N is also possible. Now the space occupied by the Blocktype is even completely saved, greatly improving resource utilization.

Users may be classified into the SISO user, the MCW user and the SCW user, and for the Blocktype of the user of each type, a different interlacing pattern or scrambling code is used.

According to this embodiment of the present invention, a method for interleaving and processing a sequence resulted from adding the CRC bits to the original sequence is employed. Different interlacing patterns are used to distinguish different types for the Blocktype. Meanwhile in the modifying process, the sequence resulted from adding the CRC bits to the original sequence is scrambled and then coded, rather than like the data transmission where scrambling of the sequence resulted from adding the CRC bits to the original sequence is performed after coding, interleaving and repeating the sequence resulted from adding the CRC bits to the original sequence.

In an exemplary implementation, the users may further be classified into different types among which the Blocktype may be reused, and the transmission type may be acquired through the negotiation of the AT and the AN. Thus, each type of content uses a method for distinguishing the Blocktype with different interlacing patterns or scrambling codes. That is, the transmission type may be first acquired according to the negotiation between the AT and the AN during the link initialization, and when the transmission type is acquired, the bit number occupied by the Blocktype is configured according to the number of modes of adding information.

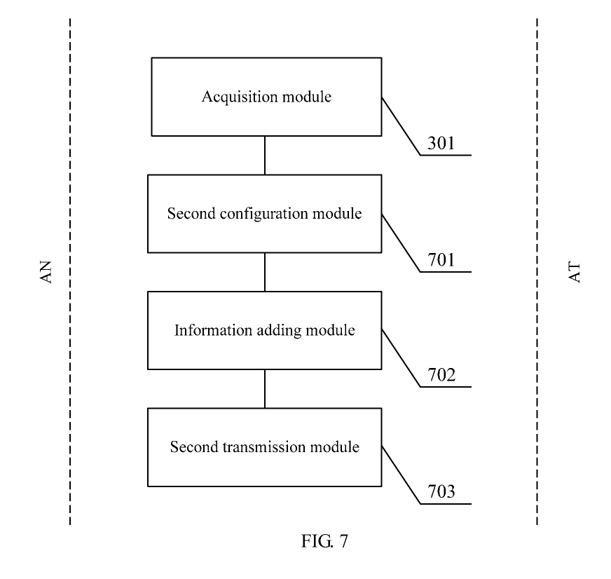

According to the same design concept, a system for transmitting messages over the F-SCCH according to another embodiment of the present invention is provided. FIG. 7 is an architecture diagram illustrating the system for transmitting messages over the F-SCCH according to another embodiment of the present invention. As shown in the figure, the system includes a second configuration module 701, an information adding module 702 and a second transmission module 703. The second configuration module 701 is adapted to set the number of modes of adding information according to the number of transmission types included in the Blocktype of the messages of the F-SCCH and configure the bit number occupied by the Blocktype according to the number of modes of adding information. The information adding module 702 is adapted to add information to the messages transmitted between the AN and the AT according to the modes of adding information. The second transmission module 703 is adapted to transmit the messages according to the configured bit number of the Blocktype, confirm a transmission type through the added information and process the messages with the corresponding transmission type.

In an exemplary implementation, the system further includes an acquisition module 301 that is adapted to acquire the transmission type according to the negotiation between the AT and the AN during the link initialization, and the second configuration module 701 is adapted to configure the bit number occupied by the Blocktype according to the number of modes of adding information, when the transmission type is acquired.

In an exemplary implementation, the mode of adding information may be but not limited to the interleaving or the scrambling.

In an exemplary implementation, the CRC bits in the original message may be used in the added information and confirming the transmission type through the added information is confirming the transmission type through the CRC bits in the added information. To decrease complexity of the receiving process, the information bits are scrambled directly after adding the CRC bits are added and then the other processings are performed. Thus, the receiving terminal only needs to try de-scrambling with different scrambling codes and then verifies the CRC bits, without other complex operations such as multiple decoding.

The present scheme simplifies a channel structure of the F-SCCH, saves channel resources, improves a channel utilization ratio while not increasing overhead and complexity. Although the processing overhead is increased, the space occupied by the Blocktype may be partly or totally saved, which greatly improving resource utilization.

Users are classified into different types and the Blocktype may be reused among the types of users. Meanwhile, in the scheme in which different interlacing patterns or scrambling codes are used for distinguishing the Blocktype for each type of content, resources of the Blocktype may be saved completely with complexity slightly increased.

The resources of the Blocktype saved in the present invention may be used for expanding the types for the Blocktype.

One skilled in the art may make various changes and modifications to the present invention without departing from the spirit and scope of the present invention. The present invention is thus intended to include these changes and modifications if they are within the scope of the claims and their equivalents.

1. A method for transmitting messages over a forward link shared signaling channel (F-SCCH), comprising:
acquiring a transmission type according to a negotiation between an access terminal (AT) and an access network (AN) during a link initialization;
configuring a bit number occupied by a message type in the F-SCCH; and
communicating based on the determined transmission type, by the AN, messages with the AT over the F-SCCH according to the configured bit number of the message type.

2. The method of claim 1, wherein the transmission type is single-input single-output (SISO), multiple-input multiple-output multiple codeword (MIMO MCW) or multiple-input multiple-output single codeword (MIMO SCW).

3. The method of claim 2, wherein the message type for transmission includes Access Grant, forward link assignment message (FLAM) and reverse link assignment message (RLAM) when the transmission type is SISO,
the message type for transmission includes Access Grant, multiple codeword forward link assignment message 1 (MCW FLAM 1), multiple codeword forward link assignment message 2 (MCW FLAM 2) and the RLAM are used when the transmission type is MIMO MCW, and
the message type for transmission includes Access Grant, single codeword forward link access block (SCW FLAB) and RLAM when the transmission type is MIMO SCW.

4. The method of claim 3, wherein:
a message of the Access Grant is transmitted separately.

5. The method of claim 4, wherein:
the AT transmits the MCW FLAM 1 and the MCW FLAM 2 messages in turn when transmitting assignment messages to the AN in case the transmission type is MIMO MCW.

6. A system for transmitting messages over an F-SCCH in a wireless communication system including an AN and an AT, comprising:
an acquisition module adapted to acquire a transmission type according to a negotiation between the AT and the AN during a link initialization;
a first configuration module adapted to configure a bit number occupied by a message type in the F-SCCH; and
a first transmission module adapted to transmit messages between the AN and the AT over the F-SCCH according to the bit number of the message type configured by the first configuration module and the transmission type determined by the acquisition module.

7. The system of claim 6, wherein the transmission type is SISO, MIMO MCW or MIMO SCW.

8. The system of claim 7, wherein the first transmission module comprises a first transmission unit, a second transmission unit and a third transmission unit, wherein:
the first transmission unit is adapted to transmit messages when the transmission type is SISO, the message type in the messages including Access Grant, FLAM and RLAM;
the second transmission unit is adapted to transmit messages when the transmission type is MIMO MCW, the message type in the messages including Access Grant, MCW FLAM 1, MCW FLAM 2 and RLAM; and
the third transmission unit is adapted to transmit messages when the transmission type is MIMO SCW, the message type in the messages including Access Grant, SCW FLAB and RLAM.

9. The system of claim 7, wherein the first transmission module comprises a fourth transmission unit, a fifth transmission unit, a sixth transmission unit and a seventh transmission unit, wherein
the fourth transmission unit is adapted to transmit an access grant message;
the fifth transmission unit is adapted to transmit messages when the transmission type is SISO, the message type in the messages including FLAM and RLAM;
the sixth transmission unit is adapted to transmit messages when the transmission type is MIMO MCW, the message type in the messages including RLAM, MCW FLAM 1, and MCW FLAM 2; and
the seventh transmission unit is adapted to transmit messages when the transmission type is MIMO SCW, the message type in the messages including SCW FLAB and RLAM.

10. The system of claim 7, wherein the first transmission module comprises a fourth transmission unit, a fifth transmission unit, a sixth transmission unit and a seventh transmission unit, wherein
the fourth transmission unit is adapted to transmit an access grant message;
the fifth transmission unit is adapted to transmit messages when the transmission type is SISO, the message type in the messages including FLAM and RLAM;
the sixth transmission unit is adapted to transmit messages when the transmission type is MIMO MCW, the message type in the messages including RLAM, MCW FLAM 1, and MCW FLAM 2;
the seventh transmission unit is adapted to transmit messages when the transmission type is MIMO SCW, the message type in the messages including SCW FLAB and RLAM,
the sixth transmission unit is adapted to transmit MCW FLAM 1 and MCW FLAM 2 in turn when the AT transmits assignment messages to the AN in case the transmission type is MIMO MCW.

11. A method for transmitting messages over an F-SCCH comprising:
setting a number of modes of adding information according to the number of transmission types included in a message type of messages of the F-SCCH and configuring a bit number occupied by the message type according to the number of modes of adding information;
adding information to messages transmitted between an AN and an AT according to the mode of adding information;
transmitting the messages according to the configured bit number of the message type; and
confirming a transmission type through the added information and processing the messages with the transmission type.

12. The method of claim 11, wherein the mode of adding information is one of interleaving and scrambling.

13. The method of claim 11, comprising adding CRC bits in the added information of the transmitted messages.

14. The method of claim 12, comprising adding CRC bits to the end of the transmitted messages.

15. The method of claim 12, wherein confirming the transmission type through the added information comprises confirming the transmission type through CRC bits in the added information.

16. The method of claim 12, further comprising:
acquiring the transmission type according to a negotiation between the AT and the AN during a link initialization; and
configuring the bit number occupied by the message type according to the number of modes of adding information when the transmission type is acquired.

17. A system for transmitting messages over an F-SCCH, comprising:
a second configuration module adapted to set the number of modes of adding information according to the number of transmission types included in a message type of messages of the F-SCCH and configure a bit number occupied by the message type according to the number of modes of adding information;
an information adding module adapted to add information to the messages transmitted between an AN and an AT according to the mode of adding information; and
a second transmission module adapted to transmit the messages according to the configured bit number of the message type, confirm the transmission type through the added information and process the messages with the transmission type.

18. The system of claim 17, wherein the mode of adding information is one of interleaving and scrambling.

19. The system of claim 17, wherein CRC bits are added in the added information of the transmitted messages.

20. The system of claim 19, wherein the CRC bits are added to the end of the added information of the transmitted messages.
